(19) United States
(12) Patent Application Publication
(10) Pub. No.: US 2009/0295667 A1
(43) Pub. Date: Dec. 3, 2009

(54) ULTRA HIGH FREQUENCY PLANAR ANTENNA

(75) Inventors: Tzyh-ghuang Ma, Taipei (TW); Ren-ching Hua, Taipei (TW); Jyh-woei Tsai, Taipei (TW)

Correspondence Address: KIRTON AND MCCONKIE, 60 EAST SOUTH TEMPLE,, SUITE 1800, SALT LAKE CITY, UT, 84111, US

(73) Assignee: National Taiwan University of Science and Technology, Taipei (TW)

(21) Appl. No.: 12/325,366

(22) Filed: Dec. 1, 2008

(30) Foreign Application Priority Data
May 30, 2008 (TW) 097120197

(51) Int. Cl. H01Q 9/16

(52) U.S. Cl. 343/795; 343/818

(57) ABSTRACT

An ultra high frequency antenna includes a first plane, a second plane opposite to the first plane by a distance, a driven dipole, at least a parasitic element having an indentation, and a balun. The balun includes a coplanar strip line and a microstrip line which has a first strip, a second strip area parallel to the first strip, and a third strip perpendicular to the first and second strips. The coplanar strip line coupled to a truncated ground plane with two narrow slots. The present planer antenna features a compact size, wide impedance bandwidth, moderate gain, and excellent front-to-back ratio. This antenna is well suitable for the applications in RFID handheld readers.

### RELATED APPLICATIONS

This application claims the priority of Taiwan Patent Application No. 097120197, filed on May 30, 2008. This invention is partly disclosed in a published article, Ren-Chi Hua, and Tzyh-Ghuang Ma, “A Printed Dipole Antenna for Ultra High Frequency (UHF) Radio Frequency Identification (RFID) Handheld Reader,” IEEE TRANSACTIONS ON ANTENNAS AND PROPAGATION, VOL. 55, NO. 12, DECEMBER 2007

### BACKGROUND OF THE INVENTION

1. Field of the Invention

The present invention relates to an ultra high frequency planer antenna, more particularly, to an ultra high frequency planer antenna for ultra-high-frequency (UHF) radio frequency identification (RFID) systems.

2. Description of the Related Art

In recent years, ultra-high-frequency radio frequency identification systems have drawn more and more attentions in a wide variety of applications such as automatic retail item management, warehouse management, access control system, electronic toll collection, and etc. For the applications involving item-level management, a RFID handheld reader plays an important role owing to its advantages of compactness, flexibility and maneuverability. By incorporating with a personal data assistant (PDA), a RFID handheld reader has the ability to provide a total solution for retail or library automation management. It is noted that, however, the antenna design in a RFID handheld reader should fulfill several unique requirements. First of all, the reader antenna in a passive RFID system should demonstrate a somewhat lower return loss level than that in a usual communication system. It is because in such a system the backscattered signal from the tag is relatively weak, and prone to be interfered by the strong reflected signal from the reader antenna terminal. Secondly, in accordance with the emission regulation, the peak gain of a linear-polarized reader antenna must not exceed 6 dBi in order to prevent the reader from violating the maximum allowed EIRP, i.e. 4 W in North America. Moreover, regarding the public exposure to electromagnetic fields and the associated health issue, it would be beneficial if one could design a RFID handheld reader antenna with high front-to-back ratio so that the absorbed electromagnetic energy by the users can be substantially reduced.

### SUMMARY OF THE INVENTION

Briefly summarized, an ultra high frequency planer antenna comprises a first plane, a second plane opposite to and separated from the first plane by a gap, a driven dipole disposed on the second plane, a parasitic element disposed on the second plane, and a balun. The balun comprises a coplanar strip line and a microstrip line which has a first strip, a second strip area parallel to the first strip, and a third strip perpendicular to the first and second strip, the coplanar strip line coupled to a truncated ground plane. A width of the microstrip line is 2 mm. The coplanar strip line is disposed on the second plane. The microstrip line is disposed on the first plane. The second plane is separated from the first plane by the gap of 1 mm.

According to the present invention, an ultra high frequency planer antenna comprises a first plane, a second plane opposite to and separated from the first plane by a gap, a driven dipole disposed on the second plane, a first parasitic element comprising an indentation, disposed on the second plane, a second parasitic element disposed on the second plane, and a balun. The balun comprises a coplanar strip line and a microstrip line which has a first strip, a second strip area parallel to the first strip, and a third strip perpendicular to the first and second strip, the coplanar strip line coupled to a truncated ground plane and the truncated ground plane comprising two slots. A length of each of the two slots is 42 mm, and a width of each of the two slots is 1 mm. A width of the microstrip line is 2 mm. The coplanar strip line is disposed on the second plane. The microstrip line is disposed on the first plane. The second plane is separated from the first plane by the gap of 1 mm.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 shows a first plane of an Ultra High Frequency (UHF) radio frequency planar antenna 10 according to a first embodiment of the present invention.

FIG. 2 shows a second plane of the ultra high frequency radio frequency plane antenna according to a first embodiment of the present invention.

FIG. 3 depicts an enlarged diagram of area A shown in FIG. 1.

FIG. 4 shows a return loss of the UHF planer antenna over 0.8 GHz-1.1 GHz operating frequency.

FIG. 5 shows a second plane of the ultra high frequency radio frequency plane antenna according to a second embodiment of the present invention.

FIG. 6 depicts an enlarged diagram of area B shown in FIG. 5.

FIG. 7 shows a return loss of the UHF planer antenna over 0.8 GHz-1.1 GHz operating frequency.

FIG. 8 shows a second plane of the ultra high frequency radio frequency plane antenna according to a third embodiment of the present invention.

FIG. 9 shows a return loss of the UHF planer antenna of FIG. 8 over 0.8 GHz-1.1 GHz operating frequency.

### DETAILED DESCRIPTION OF THE INVENTION

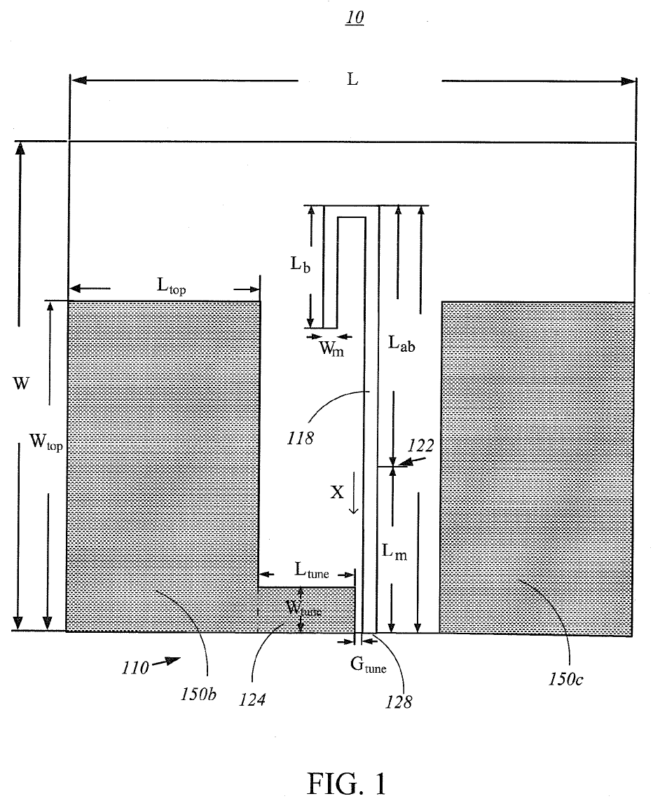

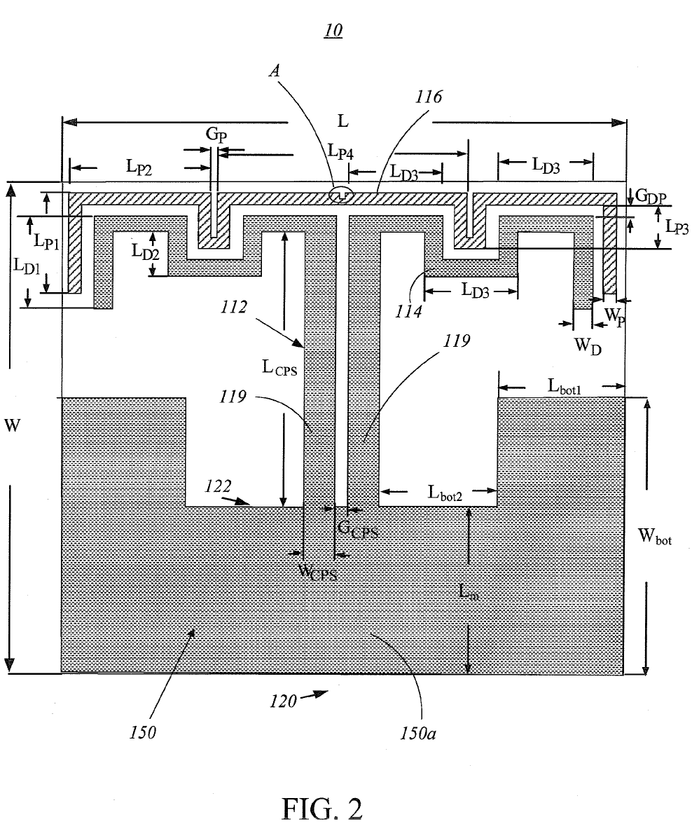

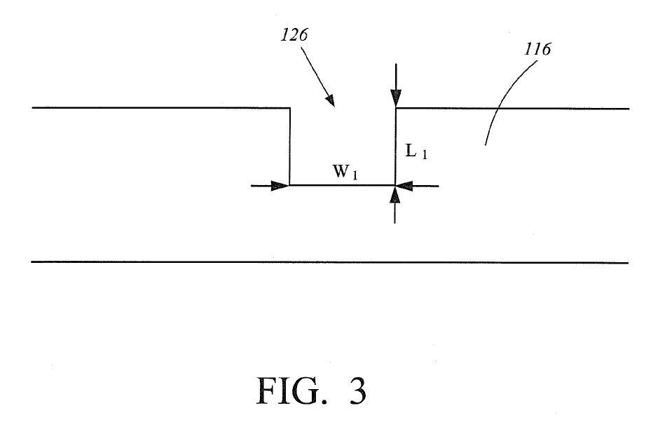

Please refer to FIGS. 1, 2 and 3. FIG. 1 shows a first plane of an Ultra High Frequency (UHF) radio frequency planar antenna 10 according to a first embodiment of the present invention, FIG. 2 shows a second plane of the ultra high frequency radio frequency plane antenna 10 according to a first embodiment of the present invention, and FIG. 3 depicts an enlarged diagram of area A shown in FIG. 1. The planar antenna 10 is designed for UHF RFID applications in North America, i.e. in the frequency range of 902-928 MHz. In this embodiment, the planar antenna 10 with a width W of 90 millimeter (mm) and a length L of 90 mm, comprises a first plane 110 and a second plane 120. The first plane 110 comprises a part of truncated ground plane 150, a balun 112, a driven dipole 114 and a parasitic element 116. The truncated ground plane 150 comprises a first truncated ground plane 150a on the second plane 120, and a second and a third truncated ground planes 150b, 150c on the first plane 110. The first truncated ground plane 150a is electrically connected to the truncated ground planes 150b, 150c via copper foil mounted on the edge of the planar antenna 10. The first plane 110 is separated from the second plane by a gap of 1 mm. The balun 112 comprises a microstrip line 118 and a coplanar strip line 119, serving as a matching network. The 50-ohms (Ω) microstrip line 118 is used to feed the planer antenna 10 via a connector 128. As shown in FIG. 1, the microstrip line 118 comprises a first strip labeled as a length of L_{b}, a second strip parallel to the first strip and labeled as lengths L_{ab} and Lₘ, and a third strip perpendicular to the first strip and the second strip. If the balance driven dipole 114 is directly connected to the unbalance microstrip line 118, high frequency electric current flows through an outer surface of the connector 128, resulting in an impact of radiation of the planer antenna 10. For solving such problem, the balun 112 blocks and suppresses the high frequency electric current flowing through the outer surface of the connector 128. The balun 112 is also capable of transforming an unbalanced input signal into a balanced one at the driven dipole 114. In the balun 112, the characteristic impedance of the coplanar strip line 119 is 130 ohms, which corresponds to a line width and gap width of W_{CPS}=5 mm and G_{CPS}=2 mm, respectively. The length of a short-circuited stub of the coplanar strip line 119 is approximately one quarter of a guided wavelength. The length of an open-circuited stub L_{b} of the microstrip line 118, on the other hand, is fine-tuned to account for the relatively small ground plane under the microstrip line 118 in the balun 112. It is found through simulation that to maximize the antenna impedance bandwidth, the optimum length of the open-circuited stub is about one-eighth of a guided wavelength long. In this embodiment, the guided wavelength is referred to as the wavelength in a 50-ohm microstrip line 118 at the center frequency of the UHF RFID band. i.e. 915 MHz. It is noted that an indentation 126 is formed on the parasitic element 116.

Similar to the quasi-Yagi antenna, the parasitic element 116 and the truncated ground plane 150 function as a director and a reflector, respectively. The lengths of the driven dipole 114 and the parasitic element 116 are optimized for simultaneously achieving excellent input impedance matching and high antenna front-to-back ratio, and the driven dipole 114 is meandered to reduce the occupied dimension. Unlike a conventional quasi-Yagi antenna, the parasitic element 116 is in close proximity to the driven element 114, and is also meandered in accordance with the outline of the driven dipole 114. Accordingly, in addition to the surface wave excited in the substrate, in the proposed planer antenna 10, the strong near-field coupling between the driven dipole 114 and the parasitic element 116 also helps improve the antenna impedance matching over a wide frequency range. The truncated ground plane 150 serving as a reflector, keeps the surface wave from propagating toward the backward direction, i.e. +x-direction. To further improve the antenna front-to-back ratio while preserving the compactness of the planer antenna 10, the first truncated ground plane 150a is folded upward to the top layer of the first plane 110. With such an arrangement, the backward-propagated surface wave can be substantially bounced back and further facilitates the end-fire radiation. Finally, a tuning stub 124 is added in the vicinity of the microstrip line 118. The tuning stub 124 is electrically connected to the truncated ground plane 150 and provides a capacitive loading between the microstrip line 118 and the truncated ground plane 150. It has the ability to further improve the antenna input impedance matching.

As shown in FIGS. 1-3, in this embodiment, lengths of all elements are Wₘ=2 mm, W_{CPS}=5 mm, G_{CPS}=2 mm, L_{D1}=17 mm, L_{D2}=8 mm, L_{D3}=15 mm, W_{D}=3 mm, L_{P1}=18 mm, L_{P2}=23 mm, L_{P3}=8 mm, L_{P4}=40 mm, Gₚ=1 mm, Wₚ=2 mm, G_{DP}=2 mm, L₁=W₁=1 mm, respectively.

Preferably, the proposed planer antenna 10 is designed on a 1-mm FR4 epoxy substrate with a dielectric constant εᵣ=4.4 and loss tangent tan δ=0.022. The overall dimension of the planer antenna 10 is 90×90 mm², or equivalently, roughly λ_{g}/2×λ_{g}/2 where λ_{g} represents a length of guide wave. Also, the element on the second plane 120 is symmetric.

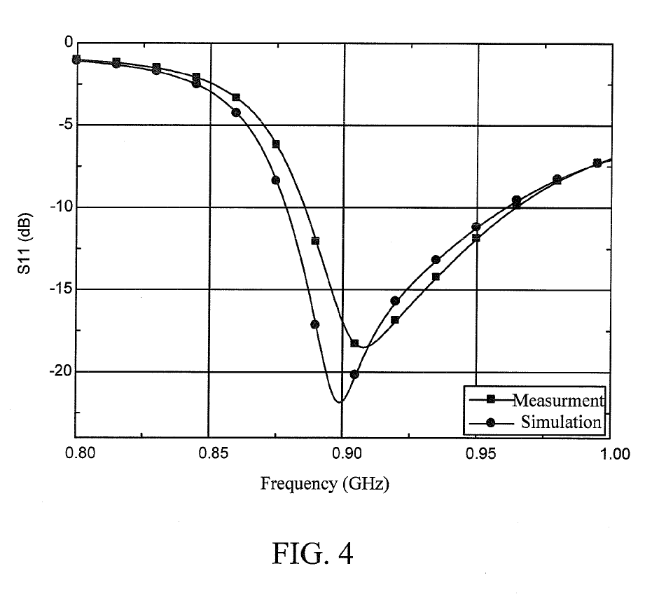

Please refer to FIG. 4 showing a return loss of the UHF planer antenna 10 over 0.8 GHz-1.1 GHz operating frequency. The simulated and measured antenna return losses are shown in FIG. 4. The simulated and measured center frequencies are given by 907 and 917 MHz, respectively. The slight frequency shift between the results can be mostly attributed to the fabrication tolerance, especially the electrical connection between the first and second planes 110 and 120. The simulated 10-dB and 14-dB return loss bandwidths are from 885 to 966 MHz and from 893 to 937 MHz, respectively, and the corresponding measurement data are given by 892-990 MHz and 898-967 MHz. The experimental results demonstrate that the planer antenna 10 completely complies with the stringent requirement of impedance matching imposed on a handheld reader antenna, and the operating bandwidth with return loss better than 14 dB covers the whole allocated spectrum for UHF RFID applications in North America. In addition, it is also noted that the 10-dB return loss bandwidth also covers the RFID spectrum licensed in Japan, which is 950-956 MHz.

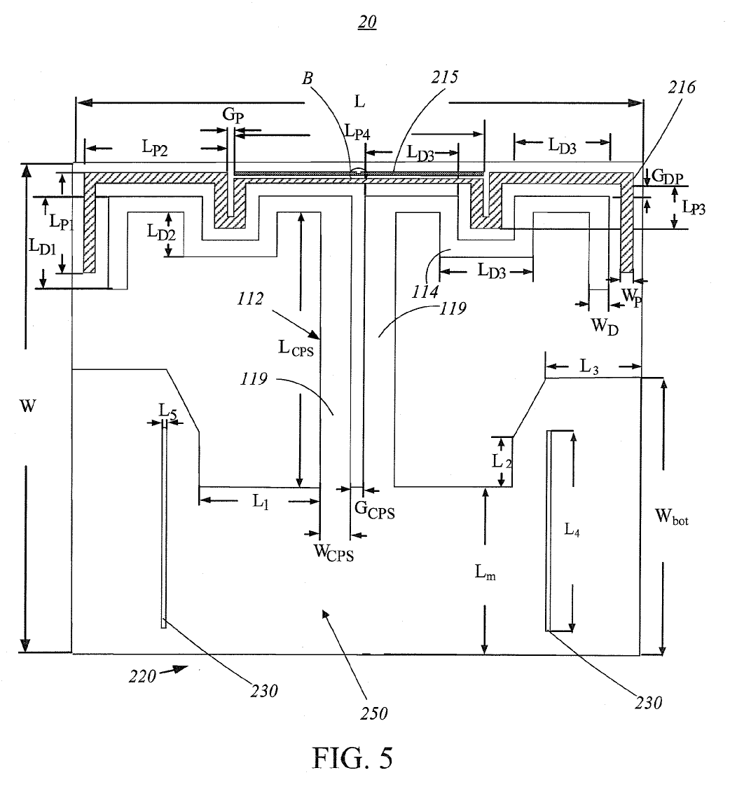

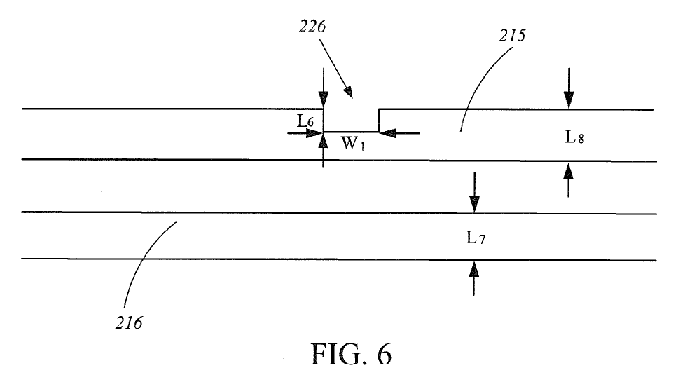

Please refer to FIGS. 1, 5 and 6. FIG. 5 shows a second plane of the ultra high frequency radio frequency plane antenna 20 according to a second embodiment of the present invention, and FIG. 6 depicts an enlarged diagram of area B shown in FIG. 5. In the second embodiment, the UHF planer antenna 20 comprises a first plane 110 and a second plane 220. For brevity, it is noted that elements in planer antenna 20 have the same function as the ones illustrated in planer antenna 10, therefore, are provided with the same item numbers as those used in planer antenna 10. In this embodiment, the planar antenna 20 with a width W of 90 millimeter (mm) and a length L of 90 mm, comprises a part of truncated ground plane 150, a balun 112, a driven dipole 114, a first parasitic element 215, and a second parasitic element 216. A width L₈ of the first parasitic element 215 is 1 mm, and a width L₇ of the second parasitic element 216 is 1 mm. The second parasitic element 216 is used for increasing return loss bandwidth and enhancing the end-fire radiation. The first plane 110 is separated from the second plane 220 by a gap of 1 mm. For brevity, since the element and outline of the first plane 110 of the antenna 20 is identical to those of antenna 10, the structure of the first plane 110 of the antenna 20 is omitted. The first parasitic element 215 on the second plane 220 comprises an indentation 226, and two narrow slots 230. As shown in FIGS. 1, 5 and 6, in this embodiment, lengths of all elements of the antenna 20 are: Wₘ=2 mm, W_{CPS}=5 mm, G_{CPS}=2 mm, L_{D1}=17 mm, L_{D2}=8 mm, L_{D3}=15 mm, W_{D}=3 mm, L_{P1}=18 mm, L_{P2}=23 mm, L_{P3}=8 mm, L_{P4}=40 mm, Gₚ=1 mm, Wₚ=2 mm, G_{DP}=2 mm, W₁=1 mm, L₆=0.5 mm, L₇=L₈=1 mm, Lₘ=30 mm, L_{ab}=50.5 mm, L_{b}=25 mm, L_{CPS}=50 mm, Wₜₒₚ=60 mm, Lₜₒₚ=30 mm, W_{bot}=50 mm, Wₜᵤₙₑ=8 mm, Lₜᵤₙₑ=16 mm, Gₜᵤₙₑ=1 mm, L₁=24 mm, L₂=10 mm, L₃=10 mm, L₄=42 mm, L₅=1 mm, respectively.

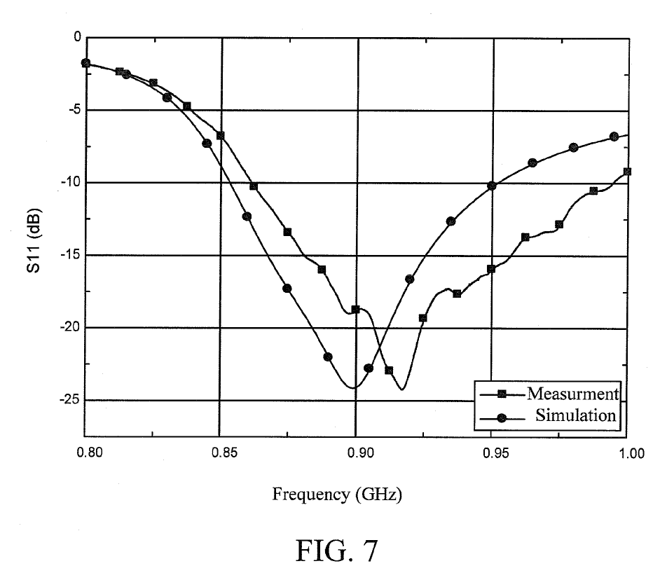

Please refer to FIG. 7 showing a return loss of the UHF planer antenna 20 over 0.8 GHz-1.1 GHz operating frequency.

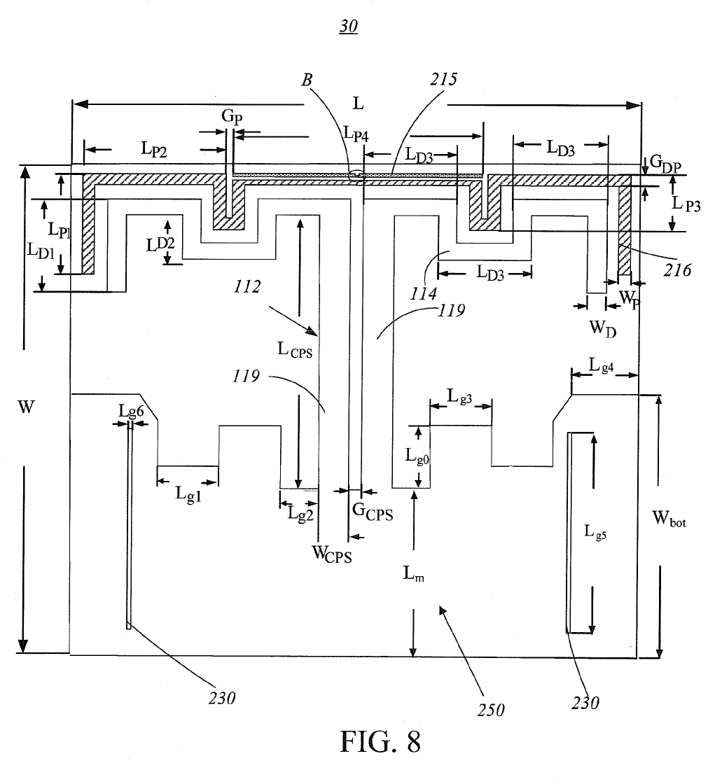

Please refer to FIG. 8. FIG. 8 shows a second plane of the ultra high frequency radio frequency plane antenna 30 according to a third embodiment of the present invention. In the third embodiment, the UHF planer antenna 30 comprises a first plane 110 and a second plane 220. For brevity, it is noted that elements in planer antenna 30 have the same function as the ones illustrated in planer antenna 20, therefore, are provided with the same item numbers as those used in planer antenna 20. In this embodiment, the planar antenna 20 has a width W of 90 millimeter (mm) and a length L of 90 mm. In this embodiment, lengths of all elements of the antenna 30 are: Wₘ=2 mm, W_{CPS}=5 mm, G_{CPS}=2 mm, L_{D1}=17 mm, L_{D2}=8 mm, L_{D3}=15 mm, W_{D}=3 mm, L_{P1}=18 mm, L_{P2}=23 mm, L_{P3}=8 mm, L_{P4}=40 mm, Gₚ=1 mm, Wₚ=2 mm, G_{DP}=2 mm, W₁=1 mm, L₁=0.5 mm, L₂=L₃=1 mm, Lₘ=30 mm, L_{ab}=50.5 mm, L_{b}=25 mm, L_{CPS}=50 mm, Wₜₒₚ=60 mm, Lₜₒₚ=30 mm, Wₜᵤₙₑ=8 mm, Lₜᵤₙₑ=16 mm, Gₜᵤₙₑ=1 mm, L_{g1}=9.5 mm, L_{g2}=6.5 mm, L_{g3}=10 mm, L_{g4}=10 mm, L_{g5}=42 mm, L_{g6}=13 mm, respectively.

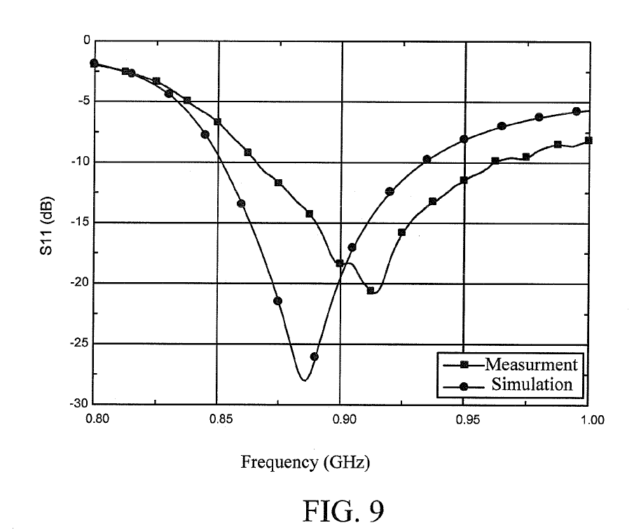

Please refer to FIG. 9 showing a return loss of the UHF planer antenna 30 over 0.8 GHz-1.1 GHz operating frequency.

The present invention planer antenna for UHF RFID handheld reader applications provides a compact size of λ_{g}/2×λ_{g}/2. The experimental results reveal that the present invention antenna features wide 14-dB return loss bandwidth of nearly 70 MHz, high front-to-back ratio from 9 to 13 dB, and moderate gain around 3 to 4.5 dBi. The antenna is well designed and may find applications in a variety of circumstances which are involved in item-level automation management with UHF RFID techniques.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structures.

What is claimed is:

1. An ultra high frequency planer antenna comprises:
a first plane;
a second plane opposite to and separated from the first plane by a gap;
a driven dipole disposed on the second plane;
a parasitic element disposed on the second plane; and
a balun comprising a coplanar strip line and a microstrip line which has a first strip, a second strip area parallel to the first strip, and a third strip perpendicular to the first and second strip, the coplanar strip line coupled to a truncated ground plane.

2. The ultra high frequency planer antenna of claim 1, wherein a width of the microstrip line is 2 mm.

3. The ultra high frequency planer antenna of claim 1, wherein the coplanar strip line is disposed on the second plane.

4. The ultra high frequency planer antenna of claim 1, wherein the microstrip line is disposed on the first plane.

5. The ultra high frequency planer antenna of claim 1, wherein the second plane is separated from the first plane by the gap of 1 mm.

6. An ultra high frequency planer antenna comprises:
a first plane;
a second plane opposite to and separated from the first plane by a gap;
a driven dipole disposed on the second plane;
a first parasitic element comprising an indentation, disposed on the second plane;
a second parasitic element disposed on the second plane;
a balun comprising a coplanar strip line and a microstrip line which has a first strip, a second strip area parallel to the first strip, and a third strip perpendicular to the first and second strip, the coplanar strip line coupled to a truncated ground plane and the truncated ground plane comprising two slots.

7. The ultra high frequency planer antenna of claim 6, wherein a length of each of the two slots is 42 mm, and a width of each of the two slots is 1 mm.

8. The ultra high frequency planer antenna of claim 6, wherein a width of the microstrip line is 2 mm.

9. The ultra high frequency planer antenna of claim 6, wherein the coplanar strip line is disposed on the second plane.

10. The ultra high frequency planer antenna of claim 6, wherein the microstrip line is disposed on the first plane.

11. The ultra high frequency planer antenna of claim 6, wherein the second plane is separated from the first plane by the gap of 1 mm.
